(19) United States
(12) Patent Application Publication
(10) Pub. No.: US 2024/0218187 A1
(43) Pub. Date: Jul. 4, 2024

(54) METHOD OF PREPARING COATED PIGMENT AND WATER-BASED INK COMPOSITION CONTAINING COATED PIGMENT PREPARED THEREBY

(71) Applicant: DONG-A PENCIL CO., LTD., Daejeon (KR)

(72) Inventors: Jin Hee SHIN, Daejeon (KR); Jungju EOM, Daejeon (KR); Nara JO, Daejeon (KR); Jung Gul AN, Daejeon (KR)

(73) Assignee: DONG-A PENCIL CO., LTD., Daejeon (KR)

(21) Appl. No.: 18/353,273

(22) Filed: Jul. 17, 2023

(30) Foreign Application Priority Data
Dec. 28, 2022 (KR) 10-2022-0187493

(51) Int. Cl. C09C 3/08; C09D 11/17; C09D 11/18

(52) U.S. Cl. CPC C09C 3/08; C09D 11/17; C09D 11/18

(57) ABSTRACT

Proposed are a method of preparing a coated pigment, which includes: preparing a pigment dispersion by mixing and dispersing first and second surfactants with a pigment in water; and coating the pigment by adding and mixing an emulsion obtained by mixing and emulsifying a monomer, a cross-linker, and a polymerizable surfactant, to and with the pigment dispersion, a water-based ink composition containing a monovalent cationic metal ion thickener and the coated pigment prepared thereby, and a water-based writing instrument including the ink composition. When preparing the coated pigment by the above method, there are advantages of improving pigment dispersion stability and adsorption stability of a coating layer and controlling strength according to the use of the cross-linker. In addition, when using the coated pigment as an ink pigment, adhesiveness and lubricity can be improved while providing a better writing experience.

### CROSS REFERENCE TO RELATED APPLICATION

The present application claims priority to Korean Patent Application No. 10-2022-0187493, filed Dec. 28, 2022, the entire contents of which is incorporated herein for all purposes by this reference.

### BACKGROUND OF THE DISCLOSURE

### 1. Field of the Disclosure

The present disclosure relates to a method of preparing a coated pigment and a water-based ink composition containing the coated pigment prepared thereby. More specifically, the present disclosure relates to a method of preparing a coated pigment using two different types of surfactants as pigment dispersants, a monomer containing a fluoroethyl group or a benzyl group as a pigment-coating agent, and a cross-linker, to a water-based ink composition containing the coated pigment prepared thereby, and to a water-based writing instrument including the water-based ink composition.

### 2. Description of the Related Art

In Egypt around 4000 B.C., a reed filled with ink was known as the first pen, and in the 6th century B.C., the nib of a quill made with the wing feathers of large birds, such as a goose or swan, was dipped in ink for use. Then, in the late 19th century, a fountain pen with a cartridge responsible for storing ink was known to be mainly used. Although fountain pens are advantageous in terms of portability, a problem of ink smudging occurs frequently. As a result, writing instruments for replacing fountain pens began to be developed. In the 1940s, when American companies manufacturing writing instruments started to mass-produce ballpoint pens, ballpoint pens became popular.

These ballpoint pens are mainly classified into oil-based ballpoint pens and water-based ballpoint pens according to the types of solvent used for ink manufacturing. In the case of an oil-based ballpoint pen using ink based on a high-boiling solvent, the ink moves only when in contact with a rolling ball. For this reason, when the rolling ball is unstable, there are problems in that pen skipping and line splitting occur easily, and ink blobs, so-called ink build-ups, are likely to be generated during writing. A water-based ballpoint pen, in which ink based on water and an organic solvent is used, has been developed for solving the problems in oil-based ballpoint pens. The water-based ballpoint pen uses water as a solvent. Thus, when simply making the tip of the ballpoint pen come into contact with paper, capillary action causes the ink to be supplied. In this case, pen skipping and line splitting hardly occur during writing, so there is an advantage in providing a smooth writing experience.

Water-based ballpoint pen inks include ink based on dyes and ink based on pigments as main colorants. Dye-based ink has a problem in that water resistance is poor. In addition, when a predetermined period elapses, the low light resistance of the dyes results in a deterioration in the quality of writing lines. Pigment-based ink is excellent in water resistance and light resistance, but the characteristics thereof differ in material, size, specific gravity, and the like depending on the types of pigment. For this reason, each pigment requires different dispersion processes. When matching color by mixing pigments of different colors, especially for obtaining a desired color, there is a problem of a reduction in ink stability due to differences in the characteristics of each pigment. To solve these problems, a variety of inks to which a method of coloring a resin or coating a surface with a pigment is applied have been proposed. Methods using a coated pigment enable good dispersion stability to be obtained and all surfaces to be uniform regardless of color. Therefore, uniform dispersion stability can be achieved during ink manufacturing, and thus the degree of freedom in selecting a mixture can be increased in ink manufacturing.

Such pigments are fine particles and thus subjected to a dispersion process using a solvent to be formed into ink. However, dispersing the pigments in a water-soluble solvent is difficult. For this reason, a technique for manufacturing water-soluble ink through dispersion using a surfactant has been developed to increase pigment affinity. Specifically, Japanese Patent Publication No. 2006-096882 relates to a water-soluble pigment-based ink composition, where ink is manufactured using a polyoxyethylene oleyl cetyl ether sulfate ester ammonium salt as a surfactant. In addition, Japanese Patent No. 4547885 relates to water-soluble ink, where pigment particles are dispersed using a cationic polymerizable surfactant and an anionic polymerizable surfactant. However, in the case of water-soluble inks containing surfactants, the ink becomes concentrated and thickened over time as in the related art, so ink flow fails to be facilitated, resulting in frequent problems that make handwriting difficult.

To solve the problems occurring when directly dispersing a pigment in a surfactant-containing solvent, as described above, a technique for improving pigment dispersibility and the physical properties of ink by pigment coating has been developed. Specifically, in JP-A No. 53-94581, carbon black is coated with a hydrophobic polymer by being dispersed in a hydrophobic vinyl monomer and thermally polymerized. In this case, the surface of the pigment is coated with a solvent-friendly material to increase the affinity with a solvent, thereby improving the dispersibility. However, the partially non-crosslinked polymers tend to be detached from the pigment and are present in a free state in an ink composition, so a coating layer is deformed over time. As a result, the stability tends to be reduced. In addition, a cross-linker, used for coating the pigment with a coating material, helps the coating material to densely form a coating layer on the surface of the pigment. In this case, the density of the coating layer may vary depending on not only the cross-linker used but also combinations of the coating material, an emulsifier used during the preparation of the coated pigment, and the monomer. Therefore, it is necessary to develop new technologies for improving pigment dispersibility, the physical properties of coated pigment, and ink stability with proper combinations of the surfactant, coating material, and cross-linker.

Hence, the inventors of the present disclosure have made an effort to conduct intensive and thorough research to overcome the problems in the related art. As a result, when preparing a coated pigment using two different types of surfactants as pigment dispersants, a monomer containing a fluoroethyl group or a benzyl group as a pigment-coating agent, and a cross-linker, there were advantages of improving pigment dispersion stability and adsorption stability of a coating layer and controlling strength according to the use of the cross-linker. In addition, when using such a coated pigment as an ink pigment, it was confirmed that adhesiveness and lubricity was improved while providing a better writing experience. As a result, the present disclosure was completed.

### DOCUMENT OF RELATED ART

### Patent Document

(Patent Document 1) JP 2006-096882 A
(Patent Document 2) JP 4547885 B2

### SUMMARY OF THE INVENTION

Therefore, the main objective of the present disclosure is to provide a method of preparing a coated pigment. Through the preparation method, stability in a pigment-coating process can be improved by increasing pigment dispersibility. In addition, a high-density coating layer can be formed on the pigment while inhibiting an increase in the strength of the coated pigment. As a result, when using the coated pigment as an ink pigment, adhesiveness and lubricity can be improved, and a smooth writing experience can be provided.

Another objective of the present disclosure is to provide a water-based ink composition containing the pigment prepared by the preparation method of the coated pigment and a monovalent cationic metal salt.

A further objective of the present disclosure is to provide a water-based writing instrument including the water-based ink composition.

According to one aspect of the present disclosure, the present disclosure provides a method of preparing a coated pigment, which includes: preparing a pigment dispersion by mixing and dispersing first and second surfactants with a pigment in water; and coating the pigment by adding an emulsion dispersion containing a monomer, a cross-linker, and a polymerizable surfactant, to the pigment dispersion.

Surfactants used as pigment-coating materials for preparing coated pigments in the related art function to increase pigment dispersibility and thus are commonly used. However, these surfactants may rather reduce the dispersibility depending on the types thereof and deteriorate the physical properties of the coated pigment according to combinations of a surfactant and a pigment-coating material. In addition, cross-linkers used to enable the coating material to densely form a coating layer on the surface of the pigment may also rather reduce the density of the coating layer according to the combination of the surfactant and the coating material. Therefore, it is important to prepare a coated pigment via proper selection and combination of a surfactant, a coating material, and a cross-linker. Hence, the inventors of the present disclosure screened surfactants, coating materials, and cross-linkers used for improving the stability in a pigment-coating process and enhancing the physical properties and functionality of the coated pigment.

In the method of preparing the coated pigment according to the present disclosure, the first surfactant may be at least one selected from the group consisting of a fatty alcohol polyglycol ether sulfate, a sodium polyoxyethylene dodecyl ether sulfate, a polyoxyethylene lauryl ether, a polyoxyethylene phosphate ester, a polyoxyethylene styrenated phenyl ether sulfate ammonium salt, a polyoxyethylene alkyl ether sulfate sodium salt, and a polyoxyethylene oleyl cetyl ether sulfate sodium salt. The first surfactant preferably is the fatty alcohol polyglycol ether sulfate, and more preferably is a polyoxyethylene oleyl cetyl ether sulfate ammonium salt. In addition, the second surfactant is represented by Formula 1.

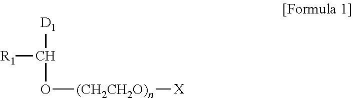

In this case,
R₁ is a functional group having 1 to 18 carbon atoms,
D₁ is

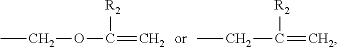

R₂ is H or CH₃,
n is an integer in a range of 10 to 20, and
X is —SO₃M, —COOM, or —PO₃M₂ (where M is an alkali metal atom, alkyl ammonium, alkanol ammonium, or ammonium, and is present in a salt form).

In the method of preparing the coated pigment according to the present disclosure, the second surfactant may be a sulfate-based surfactant and preferably is a polyoxyethylene-1-(allyloxymethyl)alkyl ether ammonium sulfate.

According to one experimental example of the present disclosure, when the fatty alcohol polyglycol ether sulfate and the surfactant according to Formula 1 were used as the first and second surfactants, respectively, pigment dispersibility was increased, so the pigment did not aggregate. However, when other surfactants were used as the second surfactant, dispersibility was reduced, resulting in pigment aggregation (see Experimental Example 1). These results show that proper selection and combination of the surfactants for preparing the pigment dispersion may help improve the dispersibility, prevent pigment aggregation, and thus improve the adsorption stability during pigment coating.

In the method of preparing the coated pigment according to the present disclosure, a monomer represented by Formula 2 may be used. In addition, to further increase the cross-linking performance, the cross-linker may be used. A polymer is cross-linkable by a cross-linker and thus contains a functional group cross-linkable by the cross-linker. The cross-linkable functional group is not particularly limited, and examples thereof may include a carboxyl group or a salt thereof, an isocyanate group, an epoxy group, and the like. However, in view of improving the dispersibility, the cross-linkable functional group preferably is a carboxyl group or a salt thereof. The cross-linker used herein may be trimethylolpropane trimethacrylate (TMP-TMA), represented by Formula 3.

In the case of using another cross-linker or not involving the cross-linker mentioned above, the density of the coating layer may be reduced, resulting in difficulty when preparing the coated pigment to be implemented in the present disclosure.

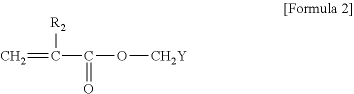

In this case,
R₂ is H or CH₃, and
Y is —CF₃ or

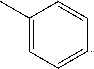

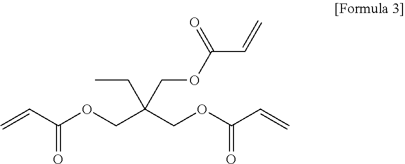 [SMILES: C=CC(=O)OCC(CC)(COC(=O)C=C)COC(=O)C=C]

In the method of preparing the coated pigment according to the present disclosure, any monomer containing a fluoroethyl group or a benzyl group may be used. However, the monomer preferably is 2,2,2-trifluoroethyl methacrylate or 2,2,2-benzyl methacrylate.

In the method of preparing the coated pigment according to the present disclosure, any surfactant conventionally used to polymerize a coating material to a pigment may be used as the polymerizable surfactant. However, the polymerizable surfactant preferably is a reactive surfactant capable of providing high adhesive strength, and more preferably is at least one reactive surfactant selected from the group consisting of dimethylaminoethyl methacrylate methyl chloride, dimethylaminoethyl methacrylate benzyl chloride, methacryloyloxyethyl trimethyl ammonium chloride, diallyldimethylammonium chloride, and 2-hydroxy-3-methacryloxypropyl trimethyl ammonium chloride.

In the method of preparing the coated pigment according to the present disclosure, a polymerization initiator may be further added in the coating of the pigment. The polymerization initiator may be at least one selected from the group consisting of aromatic ketones, acyl phosphine compounds, aromatic onium salt compounds, organic peroxides, thio compounds, hexaaryl biimidazole compounds, ketoxime ester compounds, borate compounds, azinium compounds, metallocene compounds, active ester compounds, compounds containing a carbon-halogen bond, and alkyl amine compounds. The polymerization initiator preferably is ammonium persulfate but is not limited thereto.

In the method of preparing the coated pigment according to the present disclosure, the pigment is not particularly limited, and any organic or inorganic pigment of any color may be used. The organic pigment may be at least one selected from the group consisting of azo-based pigments, phthalocyanine-based pigments, dye-based pigments, condensed polycyclic-based pigments, quinacridone-based pigments, nitro-based pigments, nitroso-based pigments, carbon black, lamp black, acetylene black, and channel black. The inorganic pigment may be at least one selected from the group consisting of metals, such as cobalt, iron, chromium, copper, zinc, lead, titanium, vanadium, manganese, nickel, and the like, metal oxides, and sulfides.

In the method of preparing the coated pigment according to the present disclosure, other components, such as moisturizers, preservatives, defoamers, pH modifiers, and the like, may be added during the preparation of the coated pigment, but examples thereof are not limited thereto.

According to another aspect of the present disclosure, the present disclosure provides a water-based ink composition containing: a coated pigment prepared by preparing a pigment dispersion by mixing and dispersing first and second surfactants with a pigment in water and coating the pigment by adding an emulsion dispersion containing a monomer, a cross-linker, and a polymerizable surfactant, to the pigment dispersion; and monovalent cationic metal ions.

In the water-based ink composition according to the present disclosure, any monovalent cationic metal ions for controlling the specific gravity so that the pigment in the ink is kept from floating or sinking and for improving sedimentation stability may be used. The monovalent cationic metal ion, a monovalent inorganic cationic salt, preferably is an alkali metal. More specifically, the monovalent inorganic cationic salt may include halides or sulfates of the alkali metal and may be, for example, at least one selected from the group consisting of lithium chloride, sodium chloride, potassium chloride, rubidium chloride, cesium chloride, lithium bromide, sodium bromide, potassium bromide, rubidium bromide, cesium bromide, lithium iodide, sodium iodide, potassium iodide, rubidium iodide, cesium iodide, lithium sulfate, sodium sulfate, potassium sulfate, rubidium sulfate, and cesium sulfate. Most preferably, the monovalent inorganic cationic salt is sodium chloride. Divalent or higher cationic metal ions themselves do not have high water solubility, form water-insoluble salts with specific anions even in a hydrated form, are likely to precipitate, and cause ink aggregation. For this reason, divalent or higher cationic metal ions are unsuitable to be added in large amounts for controlling specific gravity.

In the water-based ink composition according to the present disclosure, the ink composition may further contain any other components contained in water-based ink compositions for writing instruments. For example, the ink composition may further contain at least one selected from the group consisting of binders, surfactants, moisturizers, water-soluble organic solvents, water-soluble resins, defoamers, solubilizers, penetration modifiers, viscosity modifiers, H modifiers, antioxidants, preservatives, corrosion inhibitors, chelating agents, and antiseptics.

According to a further aspect of the present disclosure, the present disclosure provides a water-based writing instrument including a water-based ink composition containing: a coated pigment prepared by preparing a pigment dispersion by mixing and dispersing first and second surfactants with a pigment in water and coating the pigment by adding an emulsion dispersion containing a monomer, a cross-linker, and a polymerizable surfactant, to the pigment dispersion; and monovalent cationic metal ions.

The term “writing instrument” of the present disclosure is a tool that performs functions of writing, painting, drawing, and the like using ink, and includes ballpoint pens, gel ink pens, felt-tip pens, brush pens, and the like. Preferably, the writing instrument is a water-based ballpoint pen.

As described above, when using two different types of surfactants as pigment dispersants, a monomer containing a fluoroethyl group or a benzyl group as a pigment-coating agent, and a cross-linker to prepare a coated pigment, there are advantages of improving pigment dispersion stability and adsorption stability of a coating layer and controlling strength according to the use of the cross-linker. In addition, when using the coated pigment as a water-based ink pigment, especially an ink pigment for a water-based ballpoint pen, adhesiveness and lubricity can be improved while providing a better writing experience.

### DESCRIPTION OF THE PREFERRED EMBODIMENTS

Hereinafter, the present disclosure will be described in more detail through examples. These examples are intended to illustrate the present disclosure only, so the scope of the present disclosure is not to be construed as being limited by these examples.

### Example 1: Preparation of Pigment Dispersion

A pigment dispersion was prepared using components shown in Table 1. A specific method is as follows. The water-based pigment dispersion of the present disclosure may be finely dispersed using a wet dispersion technique. The components, other than the pigment, in the composition below dissolved in water. Then, the pigment was added for mixing and stirring using a stirrer. The dispersion was dispersed for about 6 hours using a bead mill (KODOBUKI UAM-150), and then large particles were removed using a centrifuge to obtain the water-based pigment dispersion (dispersion).

TABLE 1

| Example 1 | Content (wt %) |
|---|---|
| Pigment (Pigment red 150) | 35 |
| First surfactant (fatty alcohol | 5.59 |
| polyglycol ether sulfate) | |
| Second surfactant (Formula 1) | 5.36 |
| Moisturizer | 10.0 |
| Preservative | 1.0 |
| pH modifier | 1.0 |
| defoamer | 0.3 |
| Ion-exchanged water | Remainder |

### Comparative Examples 1 and 2: Preparation of Pigment Dispersion

Pigment dispersions were prepared in the same manner as in Example 1, except for using either sodium dodecyl sulfate (Comparative Example 1, anionic surfactant) or PEO nonyl phenyl ether (Comparative Example 2, nonionic surfactant) as the second surfactant.

### Experimental Example 1: Examination of Characteristics of Pigment Dispersion

The characteristics of the pigment dispersions, prepared in Example 1 and Comparative Examples 1 and 2, were examined. Specific methods of evaluating the pigment dispersions are as follows. The particle diameter was measured using a DLS particle size analyzer (Nanotrac Flex purchased from Microtrac). The particle diameter size is preferably in the range of 100 to 200 nm. The zeta potential (mV) was measured using a Malvern Zetasizer (Nano-ZS90). The greater the absolute value, preferably in the range of −50 to −100 mV, the better the dispersion. As for a microscope, a general optical microscope, Olympus BX53X, was used to evaluate the degree of dispersion. The filtering characteristics of the prepared water-based dispersion were examined using a quantitative filter paper NO.5C (1 μm) purchased from ADVANTEC to confirm whether the pigment dispersion was filtered. The results thereof are shown in Table 2.

TABLE 2

| | | Comparative | Comparative |
|---|---|---|---|
| | Example 1 | Example 1 | Example 2 |
| Size (D50, nm) | 155 | 295 | Aggregate |
| Zeta potential (mV) | −50 | −10 | −15 |
| Microscope | ◯ | X | X |
| Filter (5C) | ◯ | X | X |

As a result of the analysis, in the case of Example 1, the pigment dispersion had a particle size of 155 nm and an absolute zeta potential value of 50, as seen in Table 2. When observed with the microscope, the degree of dispersion was uniform, and factors such as sedimentation, discharge, and flow interruption were not found, confirming that the pigment dispersion was well-filtered. On the contrary, the pigment dispersions of Comparative Examples 1 and 2 had particle sizes and zeta potential values that did not fall within the appropriate range. In addition, when observed with the microscope, not only the degree of dispersion was not uniform, but also the pigment dispersions failed to be filtered due to factors such as sedimentation, discharge, and flow interruption.

### Example 2: Preparation of Coated Pigment

A coated pigment was prepared by adding a monomer represented by Formula 2 and TMP-TMA used as a cross-linker to the pigment dispersion prepared in Example 1, as shown in Table 3. A specific method is as follows. Specifically, ammonium persulfate and the pH modifier were added to the pigment dispersion (dispersion). Then, an emulsion obtained by mixing and emulsifying the vinyl monomer, the cross-linker, and the surfactant was added dropwise and mixed with stirring. Even though monomer microparticles (emulsion) of the pigment dispersion were dispersed in water immediately after dropwise addition, when being stirred for 30 minutes after the completion of dropwise addition, all the monomer particles of the emulsion were well-adsorbed and thus were not visually observed. Then, the resulting pigment dispersion was heated to raise a temperature to 70° C., and the same temperature was maintained for 4 to 5 hours with stirring. Lastly, a filtering process (using NO.5C) was performed.

TABLE 3
Example 2

| | |
|---|---|
| Pigment dispersion of Example 1 | 519.48 |
| (water-based dispersed) | |
| Moisturizer | 5.0 |
| pH modifier | 5.0 |
| Ammonium persulfate | 5.0 |
| Monomer (2,2,2-trifluoroethyl | 34.2 |
| methacrylate) | |
| Butyl acrylate | 34.4 |
| Cross-linker (TMP-TMA) | 4.4 |
| Emulsifier | 6.0 |
| Ion-exchanged water | 60.0 |

### Comparative Examples 3 and 4: Preparation of Coated Pigment

Coated pigments were prepared in the same manner as in Example 2, except that TMP-TMA serving as the cross-linker was not involved (Comparative Example 3), or a cross-linker other than TMP-TMA was used (Comparative Example 4). A specific method is the same as in Example 2.

TABLE 4

| | | Comparative | Comparative |
|---|---|---|---|
| | | Example 3 | Example 4 |
| Pigment dispersion of Example 1 | | 519.48 | 519.48 |
| (water-based dispersion) | | | |
| Moisturizer | | 5.0 | 5.0 |
| pH modifier | | 5.0 | 5.0 |
| Ammonium persulfate | | 5.0 | 5.0 |
| Monomer (2,2,2-trifluoroethyl | | 34.2 | 34.2 |
| methacrylate) | | | |
| Butyl acrylate | | 34.4 | 34.4 |
| Cross- | TMP-TMA | — | — |
| linker | Polyethylene glycol | — | 4.4 |
| | diglycidyl ether | | |

| | | |
|---|---|---|
| Emulsifier | 6.0 | 6.0 |
| Ion-exchanged water | 60.0 | 60.0 |

### Experimental Example 2: Examination of Characteristics of Coated Pigment

The characteristics of the coated pigments, prepared in 5 Example 2 and Comparative Examples 3 and 4, were examined. Specifically, whether the monomer emulsion was absorbed and the dispersibility were confirmed with an optical microscope (Olympus BX53X) at a magnification of 200× for the coated pigment obtained by solution polymerization. In addition, filtering performance was examined using a quantitative filter paper NO.5C (1 μm) purchased from ADVANTEC. The results thereof are shown in Table 5.

TABLE 5

| | | Comparative | Comparative |
|---|---|---|---|
| | Example 2 | Example 3 | Example 4 |
| Microscope | ◯ | ◯ | Δ |
| Filter (5C) | ◯ | Δ | X |

As a result of the analysis, in the case of Example 2, the monomer emulsion was well-adsorbed and thus not visually observed, as seen in Table 5. However, in the case of Comparative Examples 3 and 4, the monomer emulsions were observed to remain in the form of an emulsion solution in the dispersion. In addition, in the case of Example 2, the coated pigment solution passed through the 5C filter and thus was well-filtered. However, in the case of Comparative Examples 3 and 4, the coated pigment solutions failed to be filtered and thus were clogged. This causes unreacted substances to remain in the dispersion and react when preparing an ink composition, or causes problems in writing performance.

### Example 3: Preparation of Water-Based Ink Composition and Preparation of Ballpoint Pen Containing Same Composition

A water-based ink (Table 6) containing the coated pigment, prepared in Example 2, and sodium chloride as a monovalent cationic metal salt was manufactured (numerical values in Table 6 represent parts by mass). Specifically, CNF was stirred with polysaccharide gum under high shear force for about 1 hour to prepare a pre-gel form. Subsequently, after adding the remaining components, the coated pigment was added. Then, the resulting product was uniformly mixed and stirred using a disperser to prepare an ink composition for a water-based ballpoint pen.

TABLE 6
Example 3

| | |
|---|---|
| Coated pigment (Example 2) | 30 |
| Xanthan gum (Gelzan) | 0.3 |
| CNF (Rheocrysta I-2SP) | 0.05 |
| Sodium chloride (monovalent | 2.0 |
| inorganic cationic salt) | |
| Prysurf A208B | 1.0 |
| Preservative (XL-2) | 0.2 |
| TEA | 0.5 |
| Glycerine | 10 |
| Ion-exchanged water | Remainder |

An ink container made of PP resin was filled with each ink composition prepared above and then connected with a Φ 5-mm 5 tip and a holder to manufacture a refill.

### Comparative Example 5: Preparation of Water-Based Ink Composition and Preparation of Ballpoint Pen Containing Same Composition

A water-based ink (Table 7) containing the coated pigment, prepared in Example 2, and calcium chloride as a divalent cationic metal salt was manufactured in the same manner as in Example 3 (numerical values in Table 7 represent parts by mass).

TABLE 7

| | Comparative Example 5 |
|---|---|
| Coated pigment (Example 2) | 30 |
| Xanthan gum (Gelzan) | 0.3 |
| CNF (Rheocrysta I-2SP) | 0.05 |
| Sodium chloride (monovalent | — |
| inorganic cationic salt) | |
| Calcium chloride (divalent | 2.0 |
| inorganic cationic salt) | |
| Prysurf A208B | 1.0 |
| Preservative (XL-2) | 0.2 |
| TEA | 0.5 |
| Glycerine | 10 |
| Ion-exchanged water | Remainder |

### Experimental Example 3: Examination of Water-Based Ink Viscosity

The viscosity of the water-based inks manufactured in Example 3 and Comparative Example 5 was measured at 20° C. using a rotational viscometer (Brookfield viscometer DV2T) at 6 rpm and 60 rpm. The results thereof are shown in Table 8.

TABLE 8

| | Example 3 | Comparative Example 5 |
|---|---|---|
| At 6 rpm | 2220 | 3800 |
| At 60 rpm | 420 | 600 |

As a result of the analysis, since the thickener is used in both Example 3 and Comparative Example 5, as seen in Table 8, thixotropy, that is, a phenomenon in which viscosity decreases when shear force acts and increases when shear force does not act, is observed. In addition, the measurement value of ink viscosity is suitably in a range of 1500 to 2500 mPa·s at 6 rpm because there is a concern that when the ink viscosity exceeds 2500 mPa·s, excessive force is needed for writing while ink followability or the dry-out characteristic of a nib deteriorates, resulting in skipping during writing. From this point of view, the viscosity of the ink, according to the present disclosure, is suitable for use as a composition for a water-based ballpoint pen.

### Experimental Example 4: Examination of Ink Stability and Evaluation of Writing Experience

The ink stability and writing experience of ballpoint pens containing either of the water-based inks, manufactured in Example 3 and Comparative Example 5, were examined.

Specifically, for the ink stability evaluation, the tip of the ballpoint pen refill stood still to be faced downward and left for 90 days under a condition at a temperature of 50° C. Then, ink conditions (layer separation, sedimentation, aggregation, viscosity, and the like) in the refill were examined with the naked eye and then observed with a microscope at room temperature. In addition, for the writing experience, ISO14145-1 standard writing test was performed on each sample using a writing tester (HUTT HT10). Then, the ball abrasion was measured using a microscope (Mitutoyo TOOLMAKER'S microscope having a 50× magnification). The results thereof are shown in Table 9.

TABLE 9

| | | | Comparative |
|---|---|---|---|
| | | Example 3 | Example 5 |
| Ink stability | | ◯ | X (thickened) |
| Writing | Writing line | ◯ | X |
| test | skipping | | |
| | Writing line | ◯ | X |
| | clogging | | |
| | Dry-resistance | 8 | — |

As a result of the analysis, in the case of adding the divalent cations (Comparative Example 5), the divalent cations react with the components of the ink, as seen in Table 9, thus forming a gel phase, making handwriting difficult. In the case of adding the monovalent cations (Example 3), ink stability was excellent without ink precipitation, separation, or aggregation over time. Even when performing the writing test on the refill manufactured in Example 3, good handwriting and excellent TIP lubricity were shown until the completion of the test.

What is claimed is:

1. A method of preparing a coated pigment, the method comprising:
preparing a pigment dispersion by mixing and dispersing first and second surfactants with a pigment in water; and
coating the pigment by adding and mixing an emulsion obtained by mixing and emulsifying a monomer, a cross-linker, and a polymerizable surfactant, to and with the pigment dispersion.

2. The method of claim 1, wherein the first surfactant is a fatty alcohol polyglycol ether sulfate, and
the second surfactant is represented by Formula 1, 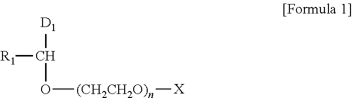
wherein R₁ is a functional group having 1 to 20 carbon atoms,
D₁ is 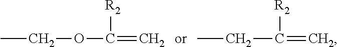
R₂ is H or CH₃,
n is an integer in a range of 10 to 20, and
X is —SO₃M, —COOM, or —PO₃M₂ (where M is an alkali metal atom, alkyl ammonium, alkanol ammonium, or ammonium, and is present in a salt form).

3. The method of claim 2, wherein the second surfactant is a polyoxyethylene-1-(allyloxymethyl)alkyl ether ammonium sulfate.

4. The method of claim 1, wherein the monomer is represented by Formula 2, and
the cross-linker is trimethylolpropane-trimethacrylate (TMP-TMA), 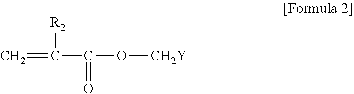
wherein R₂ is H or CH₃, and
Y is —CF₃ or

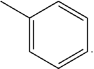

5. The method of claim 4, wherein the monomer is 2,2,2-trifluoroethyl methacrylate or 2,2,2-benzyl methacrylate.

6. The method of claim 1, wherein the polymerizable surfactant is at least one reactive surfactant selected from the group consisting of dimethylaminoethyl methacrylate methyl chloride, dimethylaminoethyl methacrylate benzyl chloride, methacryloyloxyethyl trimethyl ammonium chloride, diallyldimethylammonium chloride, and 2-hydroxy-3-methacryloxypropyl trimethyl ammonium chloride.

7. A water-based ink composition comprising:
the coated pigment prepared according to claim 1; and
a monovalent cationic metal ion.

8. The ink composition of claim 7, wherein the monovalent cationic metal ion is sodium chloride.

9. The ink composition of claim 7, wherein the ink composition has a viscosity in a range of 1500 mPa·s to 2500 mPa·s when being measured using a DV2T viscometer at a temperature of 20° C. and a rotation speed of 6 rpm.

10. A water-based writing instrument comprising the ink composition of claim 7.
